(19) United States
(12) Patent Application Publication
(10) Pub. No.: US 2025/0138521 A1
(43) Pub. Date: May 1, 2025

(54) MACHINE LEARNING-BASED ANOMALY DETECTION FOR REPETITIVE TASKS PERFORMED USING EDGE INSTRUMENTS

(71) Applicant: Dell Products L.P., Round Rock, TX (US)

(72) Inventors: Sivaprakasam Rajappan, Banglore (IN); Dhilip S. Kumar, Bangalore (IN); Rajesh Krishnan, Bangalore (IN); Shadab Ali, Nawanda (IN)

(21) Appl. No.: 18/496,326

(22) Filed: Oct. 27, 2023

(51) Int. Cl. G05B 23/02

(52) U.S. Cl. CPC G05B 23/0243; G05B 23/0221; G05B 23/027

(57) ABSTRACT

Techniques are provided for machine learning-based anomaly detection for repetitive tasks performed using edge instruments. One method includes obtaining sensor data characterizing an orientation and/or an acceleration of an edge instrument utilized to perform a repetitive task, comprising a sequence of actions, by a user. The sensor data is obtained from at least one sensor embedded in the edge instrument. The sensor data is applied to a machine learning model trained to identify a deviation from an expected sequence of actions associated with the repetitive task. The machine learning model is embedded in the edge instrument. An automated action is initiated in response to the machine learning model identifying the deviation from the expected sequence of actions.

### BACKGROUND

Many items are assembled in a manufacturing environment. Quality inspections are typically performed on the completed item at the end of an assembly process. Defects in the assembly process, however, may impair the quality of a completed item.

### SUMMARY

Illustrative embodiments of the disclosure provide techniques for machine learning-based anomaly detection for repetitive tasks performed using edge instruments. One method includes obtaining sensor data characterizing at least one of an orientation and an acceleration of an edge instrument utilized to perform a repetitive task by a user, wherein the sensor data is obtained from one or more sensors embedded in the edge instrument and wherein the repetitive task comprises a sequence of actions; applying the sensor data to a machine learning model trained to identify one or more deviations from an expected sequence of actions associated with the repetitive task, wherein the machine learning model is embedded in the edge instrument; and initiating at least one automated action in response to the machine learning model identifying the one or more deviations from the expected sequence of actions.

Illustrative embodiments can provide significant advantages relative to conventional defect detection techniques. For example, challenges associated with detecting anomalies with respect to repetitive tasks, such as repetitive tasks involved in the assembly of an item, are overcome in one or more embodiments by applying sensor data characterizing an orientation and an acceleration of an edge instrument utilized to perform a given repetitive task to a machine learning model trained to identify deviations from an expected sequence of actions associated with the repetitive task.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for machine learning-based anomaly detection for repetitive tasks performed using edge instruments in an illustrative embodiment;

FIG. 2 illustrates an edge instrument of FIG. 1 in further detail, in an illustrative embodiment;

FIG. 3 is a flow diagram of a machine learning process in an illustrative embodiment;

FIGS. 4A through 4C illustrate exemplary edge instruments, in accordance with illustrative embodiments;

FIG. 5 is a flow diagram illustrating an exemplary implementation of a process for machine learning-based anomaly detection for repetitive tasks performed using edge instruments, in accordance with an illustrative embodiment;

FIG. 6 is a process diagram illustrating a training of a machine learning model to identify patterns in training data and a use of the trained machine learning model for anomaly detection, according to one embodiment of the disclosure;

FIGS. 7A through 7C illustrate an exemplary edge instrument being used for a repetitive task, a table comprising a sequence of steps associated with the repetitive task, and a short-hand representation of the sequence of steps associated with the repetitive task, respectively, in accordance with illustrative embodiments;

FIGS. 8A and 8B, collectively, comprise sensor readings generated by an exemplary edge instrument, over time, for a sequence of steps associated with a repetitive task, in accordance with an illustrative embodiment;

FIGS. 9A and 9B are flow diagrams illustrating exemplary implementations of, respectively, a process that trains a machine learning model to identify patterns in training data and a process that employs the trained machine learning model for anomaly detection according to embodiments of the disclosure;

FIG. 10 illustrates an exemplary edge instrument being used for a repetitive task in the presence of an anomalous sequence of steps, in accordance with an illustrative embodiment;

FIG. 11 is a flow diagram illustrating an exemplary implementation of a process for machine learning-based anomaly detection for repetitive tasks performed using edge instruments, in accordance with an illustrative embodiment;

FIG. 12 illustrates an exemplary processing platform that may be used to implement at least a portion of one or more embodiments of the disclosure comprising a cloud infrastructure; and

FIG. 13 illustrates another exemplary processing platform that may be used to implement at least a portion of one or more embodiments of the disclosure.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple net worked processing devices.

Modern factories often use sophisticated machinery to manufacture items, but typically rely on humans to identify defects in various tasks, many of which are repetitive in nature (e.g., tightening screws and assembling components, such as inserting a hard drive into a slot). Such repetitive tasks may be performed by humans or robots. When humans are involved in item assembly activities, for example, there is often an opportunity for one or more errors (e.g., skipping one or more steps in an assembly procedure) to cause quality issues in the assembled item.

One or more aspects of the disclosure recognize that a proactive strategy for managing the quality function in the assembly of an item can provide early detection of errors in the assembled item. In one or more embodiments, techniques are provided for machine learning-based anomaly detection for repetitive tasks performed using edge instruments, such as tools (e.g., screwdrivers, hammers, wrenches, robotics, etc.) and/or gloves having one or more embedded sensors for monitoring the repetitive tasks. In some embodiments, the one or more embedded sensors perform data collection, and may include embedded code to remove noise from the collected sensor data before the sensor data is applied to an anomaly detection model trained to identify deviations from learned assembly patterns. A training process learns assembly patterns for a given action and a user can be notified, for example, if a deviation from a given learned assembly pattern is detected.

Consider an assembly worker that uses a screwdriver having one or more embedded sensors to monitor the assembly worker screwing one or more screws into a laptop being produced. In another variation, the assembly worker may wear a glove having one or more embedded sensors to perform the assembly using a conventional screwdriver. When the screwdriver, for example, moves its axis, the gravitational acceleration can be measured to study the movement of the screwdriver. When the screwdriver rotates, the speed and rotation around an axis of an object can be captured and evaluated, as discussed further below. For example, if the assembly worker fails to insert a given screw, the trained anomaly detection model can detect the failure and initiate a real-time notification to the assembly worker or another user. In this manner, the notification provides an opportunity for the error to be resolved early in the manufacturing or assembly process.

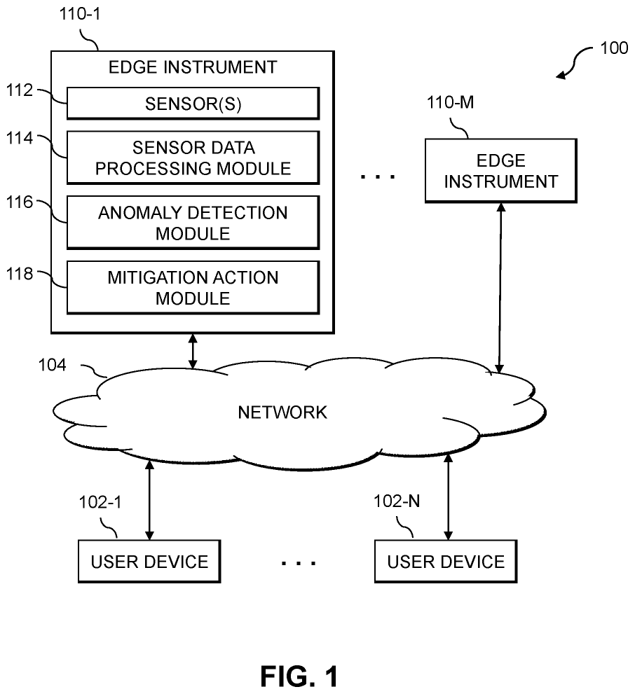

FIG. 1 shows a computer network (also referred to herein as an information processing system) 100 configured in accordance with an illustrative embodiment. The computer network 100 comprises a plurality of user devices 102-1 . . . 102-N, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 are edge instruments 110-1 . . . 110-M (collectively referred to herein as edge instruments 110).

The edge instruments 110, in some embodiments, are used to perform one or more repetitive tasks, such as in an assembly line. The edge instruments 110 may be located in one or more geographic locations. The term “edge instrument” as used herein is intended to be broadly construed, so as to encompass, for example, processor-based tools (e.g., screwdrivers, hammers, wrenches, robotics, etc.), processor-based gloves and/or other processor-based instruments for performing repetitive tasks.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

Also associated with the user devices 102 are one or more input-output devices, which illustratively comprise keyboards, displays or other types of input-output devices in any combination. Such input-output devices can be used, for example, to support one or more user interfaces to the user devices 102, as well as to support communication between the one or more edge instruments 110 and/or other related systems and devices not explicitly shown.

The network 104 is assumed to comprise a portion of a global computer network such as the Internet, although other types of networks can be part of the computer network 100, including a wide area network (WAN), a local area network (LAN), Narrowband-IoT (NB-IoT), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

The edge instrument 110-1 includes one or more sensors 112, sensor data processing module 114, an anomaly detection module 116 and a mitigation action module 118. In at least some embodiments, the one or more sensors 112 are embedded in physical devices, such as a tool used in an assembly line to perform an activity or a glove worn by an assembly worker to perform the activity. The sensors 112, in some embodiments, may correspond to a sensor array comprising one or more IoT (Internet of Things) sensors. The IoT sensors may alternatively be referred to as IoT edge sensors and include, but are not limited to, sensors, actuators or other devices that produce information and/or are responsive to commands to measure, monitor and/or control the environment that they are in. Sensors within the scope of this disclosure may operate automatically and/or may be manually activated. In general, the type, number, location, and combination of sensors can be based on considerations including, but not limited to, the type(s) of anomalies most likely to be encountered in a given assembly line, the proximity of potential anomaly sources, and the amount of time needed to implement one or more mitigative actions once an anomaly has been identified.

In some embodiments, the sensor data processing module 114 transforms the data from the sensors 112 into a format that can be consumed by the anomaly detection module 116 (e.g., by compressing the sensor data and/or reducing noise in the sensor data, as discussed further below). Sensor data is often small so compression may not be needed in some implementations. The compression may employ one or more frameworks that provide for exporting machine learning models to form factors, such as mobile and/or embedded devices.

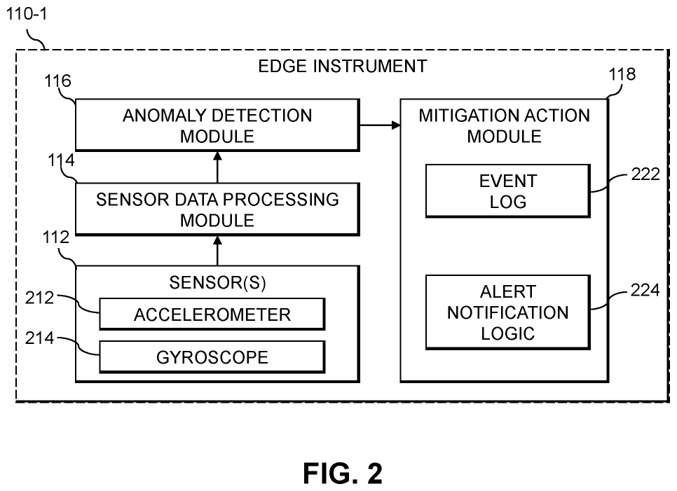

The anomaly detection module 116, in some embodiments, employs a machine learning model that analyzes the sensor data and detects potential anomalies in an assembly line process or another repetitive task. Additionally, the anomaly detection module 116 can decide on at least one automated action to at least partially mitigate such anomalies, as described in more detail below in conjunction with FIG. 2, for example.

Non-limiting examples of sensors 112 include, but are not limited to, gyroscope sensors and accelerometer sensors, as discussed further below in conjunction with FIG. 2, for example. The foregoing and/or other sensors can be employed in any combination, type, and number.

Generally, the sensors 112 are collocated with the edge instrument 110-1 so as to detect actual and/or potential anomalies with respect to a sequence of steps associated with a particular repetitive task. For example, a given sensor 112 may be implemented in one or more edge instruments 110 (e.g., tools or gloves) utilized to perform one or more of steps associated with a particular repetitive task.

As noted above, the edge instrument 110-1 may also include mitigation action module 118. Generally, the mitigation action module 118 performs at least one automated action in order to mitigate detected anomalies. For example, an automated action may include generating a notification upon detection of an anomaly, and/or identifying one or more remedial actions to perform to correct a detected anomaly with respect to the expected sequence of steps.

Additional edge instruments 110, such as edge instrument 110-M, are assumed to be implemented in a similar manner as the edge instrument 110-1 of FIG. 1.

In the FIG. 1 embodiment, the representative edge instrument 110-1 can have at least one associated database (not explicitly shown in FIG. 1) configured to store sensor data obtained from one or more sensors 112. Databases associated with one or more of the edge instruments 110, in some embodiments, can be implemented using one or more corresponding storage systems. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the other edge instruments 110 may be implemented in a similar manner as edge instrument 110-1, for example. Additionally, each of the one or more edge instruments 110 in the FIG. 1 embodiment is assumed to be implemented using at least one processing device. Each such processing device generally comprises at least one processor and an associated memory, and implements one or more functional modules for controlling certain features of the edge instruments 110. More particularly, the one or more edge instruments 110 in this embodiment can each comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interfaces allow for communication between the one or more edge instruments 110 and/or the user devices 102 over the network 104, and each illustratively comprises one or more conventional transceivers.

It is to be appreciated that the particular arrangement of elements 112, 114, 116 and 118 illustrated in the edge instrument 110-1 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of elements. As another example, multiple distinct processors can be used to implement different ones of the elements 112, 114, 116 and 118 or portions thereof.

At least portions of elements 112, 114, 116 and 118 may be implemented at least in part in the form of software that is stored in memory and executed by at least one processor.

It is to be understood that the particular set of elements shown in FIG. 1 for one or more edge instruments 110 and/or user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the one or more edge instruments 110 and at least at least one associated database can be on and/or part of the same processing platform.

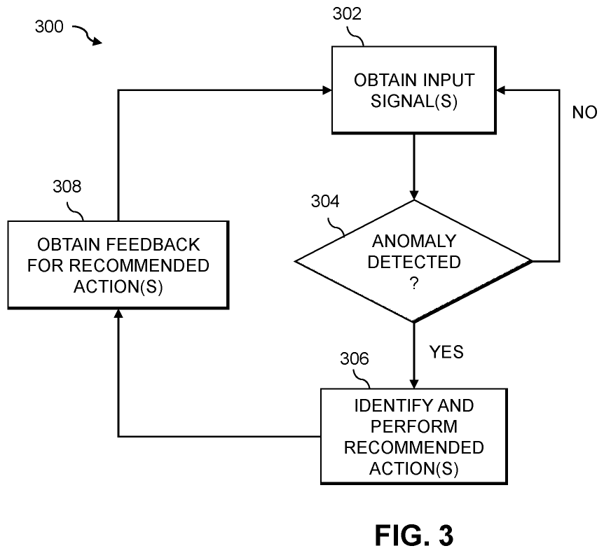

An exemplary process utilizing elements 112, 114, 116 and 118 of an example edge instrument 110-1 in computer network 100 will be described in more detail with reference to, for example, FIGS. 3, 5, 6, 9A, 9B and/or 11.

FIG. 2 illustrates the edge instrument 110-1 of FIG. 1 in further detail, in an illustrative embodiment. As noted above, the edge instrument 110-1 may include one or more sensors 112, a sensor data processing module 114, an anomaly detection module 116 and a mitigation action module 118. The one or more sensors 112 may be embedded in physical devices, such as a tool used to perform an activity or a glove worn by a user while the activity is performed.

In some embodiments, the architecture shown in FIG. 2 can correspond to at least a portion of edge instrument 110-1 as indicated by the dashed rectangle. By way of example, at least one of the sensors 112, sensor data processing module 114, anomaly detection module 116 and mitigation action module 118 can be implemented on a system on a chip (SoC) hosted within the edge instrument 110-1 that is configured to obtain data from the one or more sensors 112. In such embodiments, the SoC can take the form of, or include, a physical computing device as well, where at least one of the elements in the SoC comprise an operating system that supports appropriate libraries to host a machine learning algorithm. The operating system of the SoC can be separate from any other operating system that is associated with the edge component 101-1, for example.

In the FIG. 2 embodiment, the sensors 112 comprise an accelerometer 212 and a gyroscope 214. In one or more embodiments, the accelerometer 212 measures the acceleration force that is applied to the edge instrument 110-1 using three physical axes (x, y, and z), including the force of gravity. For example, the accelerometer 212 may measure a rate of rotation of the edge instrument 110-1 in units of radians per second around each of the three physical axes (x, y, and z). In the example of FIG. 2, the gyroscope 214 measures an angular velocity (e.g., the change in rotational angle per unit of time) of the edge instrument 110-1 to determine orientation.

In at least one embodiment, the sensor data processing module 114 transforms the sensor data from the sensors 112 into a format that can be consumed by the anomaly detection module 116 (e.g., by compressing the sensor data and/or reducing noise in the sensor data, as discussed further below). Vibration and pressure are some examples of external disturbances that may cause noise in the sensor data. As noted above, sensor data may be small and compression may not be needed in some implementations. The anomaly detection module 116, in some embodiments, employs a trained machine learning model that analyzes the sensor data generated by the one or more sensors 112 (and optionally processed by the sensor data processing module 114) and detects potential anomalies in an assembly process or another repetitive task performed using the edge instrument 110-1.

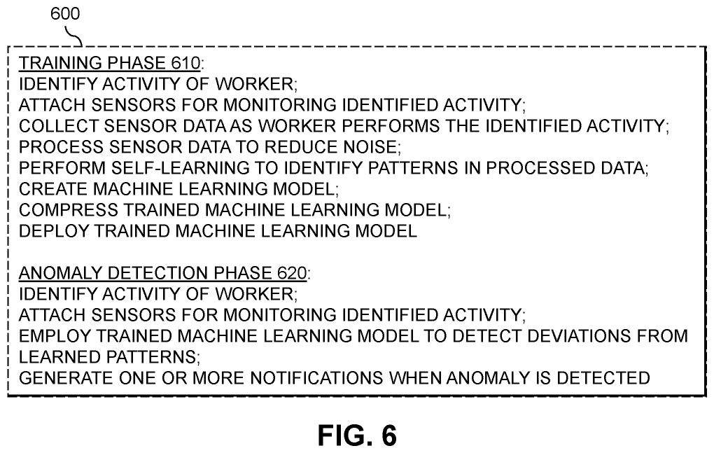

Generally, the anomaly detection module 116 implements one or more trained machine learning processes (and/or models) that are used to detect deviations from an expected sequence of steps associated with a given repetitive task, as discussed further below in conjunction with FIG. 6, for example. As used herein, in at least some embodiments, machine learning refers to a subset of artificial intelligence in the field of computer science that may use statistical techniques to give computers the ability to learn with data, that is, progressively improve performance of one or more particular tasks, without having been explicitly programmed to generate, or perform, the improved tasks.

In some embodiments, a machine learning process, such as a machine learning process based on convolutional neural networks (CNNs), can correspond to a supervised machine learning process, where the anomaly detection module 116 is presented with sensor data associated with an expected sequence of steps associated with a given repetitive task, and the anomaly detection module 116 learns to detect variations from such sensor data associated with the expected sequence of steps, as discussed further below.

As an example, in one or more embodiments, data can be obtained from sensors 112 during periods of time when different steps of the sequence of steps associated with the given repetitive task are performed. The sensor data from the different steps can be labeled with the corresponding type of step, and thus can be used as training data to train the machine learning process to detect deviations from the expected sequence.

In at least some embodiments, the anomaly detection module 116 can implement a process to learn from situations where at least one automated action is initiated in response to a possible anomaly detected using the data from the sensor data processing module 114, and where the anomaly later turns out to be a false positive. In such situations, there are costs associated with implementing the at least one automated action, and also costs associated with returning the system to a normal state of operation. Accordingly, the mitigation action module 118 for selecting and implementing automated actions may provide an automatic mechanism that can identify an acceptable balance between data and/or application availability on the one hand, and the consequences of the speed (e.g., too quickly or too slowly) in which a given automated action is taken on the other hand.

In some embodiments, the anomaly detection module 116 may employ tiny machine learning techniques for performing sensor data analytics on the edge instrument 110-1 using low power (e.g., up to the mW range). The increased availability of low cost and/or low power sensors with embedded anomaly detection may be employed to learn expected patterns of activity and to promptly detect deviations from such learned expected patterns of activity. In this manner, anomalies in a manufacturing assembly line, for example, can be detected in real time, at the particular location where the activity is performed and where the deviation occurs, thereby ensuring improved assembled item quality and a quick resolution of detected anomalies.

Additionally, in the FIG. 2 embodiment, the mitigation action module 118 includes an event log 222 and alert notification logic 224. The event log 222 can track the anomalies detected by the sensor data processing module 114, any automated actions taken in response to the detected anomalies, and received feedback to such actions. The event log 222 can provide feedback to the anomaly detection module 116 to improve results of the machine learning process, for example.

The alert notification logic 224 may comprise one or more external application programming interface (API) connectors to facilitate a particular automated action. In such embodiments, the APIs can be used to generate instructions for various detected anomalies (e.g., remediation steps when an expected action is not performed, and/or when an additional unexpected action is performed among the expected actions). Also, the alert notification logic 224 can provide notifications to an edge instrument associated with the detected anomaly and/or an external alarm system (not explicitly shown in FIG. 2). For example, the external alarm system may communicate, and operate in connection with various components (e.g., which may or may not be in the computer network 100) to implement, and/or cause the implementation of, one more of the automated actions. Such components, in some embodiments, can include a facilities management system, an operations system, or a local alarm system, as non-limiting examples.

Sensors are susceptible to environmental noise when reading data. These sensors are frequently exposed to external disturbances, such as wind pressure and rotor vibration, which can introduce noise into data readings. One or more aspects of the disclosure recognize that such noise can influence performance by responding to the difference between the actual sensor readings and the reference acceleration. In some embodiments, one or more noise reduction techniques may be applied to the sensor readings.

In some embodiments, noise reduction techniques are employed comprising one or more of a linear least mean squares estimator, a linear quadratic estimator or a Kalman filter. The Kalman filter, for example, is designed for low complexity, low memory requirements, and effective noise suppression. Estimation using the state strategy can recover information from noisy data. Thus, a Kalman filter (or a variation thereof) is used in some embodiments for noise reduction with respect to sensor readings, particularly when information regarding the frequency of noise that may occur is absent.

A Kalman filter is typically comprised of a prediction portion and an update portion. When used to reduce noise in sensor readings, the sensor data is filtered, referred to as the gain of the Kalman filter, and the value of the error is changed. The Kalman filter algorithm defines a process variance, Q, and a measurement, R. At first, an estimated state variable can have a value of zero, and a state variance variable can have a value of one.

The sensor data is then applied to the Kalman filter as a signal that has not been changed. The prediction portion is then determined, comprised of the estimated state of the prediction and the state variance of the prediction. The update portion is then determined, comprised of the Kalman gain, an updated estimated state variable, and the updated state variance variable. In the update portion, the output of the algorithm is the filtered data, which is the updated estimate of the state variable. Some other values, such as the last estimated state and the last state variance, are also saved as previous data for the next iteration as long as the looping process continues.

As noted above, the anomaly detection module 116 may employ a CNN model, which takes as an input a fusion of tri-axial accelerometer and gyroscope data that has been processed by the Kalman filter and passes the processed accelerometer and gyroscope data through one-dimensional convolutional and maximum-pooling layers. These layers effectively extract local and translation-invariant features in an unsupervised manner. The data carries sensor type gyroscope or accelerometer information after being filtered by the Kalman filter. The training dataset is generated with an indication of activities, such as acceleration, rotation, and slot fixing, as discussed further below.

The convolutional layers of the CNN model are used to generate features automatically, which are then combined with statistical features and applied to a fully-connected layer. For this solution, statistical characteristics and pre-processing are applied to the Kalman filtered data before the data is applied to the CNN model. In some embodiments, the Kalman filtered data may first be divided into time windows, in order to exploit the temporal information and periodicity of the signals. The time duration of each window is N seconds, where N is measured based on the measurement time while training with multiple iterations.

Convolutional layers create a representation of the raw sensor data, but the extracted features are local, so the global characteristics of the time series also need to be encoded. This is achieved in some embodiments by creating statistical features for each time window, which were proposed by the creators of the dataset themselves. Each time window of each channel is first centered around its average of the time series in the three axes, before being applied to the CNN model.

The convolutional layer in some embodiments provides feature extraction by exploiting the temporal information of the data. One-dimensional convolution is applied, which means that the applied filters are slid in the direction of only one dimension and not necessarily that the sensor data itself is one-dimensional. The parameters of the convolutional layer comprise a set of learnable filters. During the forward pass, each filter is convolved across the temporal axis of the input volume, and dot products are computed between the entries of the filter and the input at any position. The width of the output is calculated as follows:

$${W}_{out} = \frac{{W}_{in} - K + 2 P}{S + 1}$$

where Wᵢₙ is the width of the input. K is the kernel size of the filter, S is the stride, and P is the number of zero padding that is added, while the output depth will be equal to the number of filters F. The output of convolving the input with the filters of the layer is expressed as follows:

$${o}_{j} = f ( {\sum }_{k = 1}^{{W}_{in}} {W}_{kj} \cdot {X}_{k} + {b}_{j} ) .$$

The matrices Wₖⱼ represent the filters that are convolved with the input, Xₖ, while bⱼ is the bias vector that is added to the output. Finally, j ranges from 1 to F, the number of convolutional filters, and f(⋅) is the activation function, in a similar manner as the fully-connected layer (e.g., a ReLU activation).

Pooling layers, such as maximum-pooling layers or average pooling layers, may be used in some embodiments after a convolutional layer to reduce the complexity of the implementation and compress the representation. A maximum-pooling layer, for example, accepts an input of size H₁×W₁×D₁, with the kernel size F and stride S as parameters, and produces an output of size H₂×W₂×D₂, where

$${H}_{2} = \frac{{H}_{1} - {F}_{1}}{S + 1}$$

in the two-dimensional case, but in the one-dimensional case, it is

$${H}_{2} = {H}_{1} , {W}_{2} = \frac{{W}_{1} - {F}_{2}}{S + 1}$$

and D₂=D₁. The output comprises the maximum of every window of size F×1, which is slid across the input with stride S.

Finally, the output of the last layer is commonly passed to a softmax layer that computes the probability distribution over the predicted classes. The softmax layer is a fully-connected layer, which has the softmax function as an activation function, expressed as follows:

$$σ ( z ) j = \frac{{e}^{{z}_{j}}}{{\sum }_{k = 1}^{k} {e}^{{z}_{j}}} , j = 1 , … \cdot k$$

where k is the number of predicted classes.

In one implementation, the accelerometer data of size N×3, is applied to the first convolutional layer with 192 convolutional filters and a kernel size of 12, for example, and the stride of the convolution is 1. The ReLU function is applied to its output.

A maximum-pooling layer follows with a kernel size of 3×1 and a stride of 3, which reduces the feature representation by 3.

Another convolutional layer is added with 96 convolutional filters and a kernel size of 12, and the step of the convolution is 1. This will help to learn more abstract and hierarchical features. The ReLU function is applied to its output.

A final maximum-pooling layer has a kernel size of 3×1 and a stride of 3, which further reduces the feature representation by 3.

The output of the maximum-pooling layer is then flattened and concatenated with the statistical features as described above. The joint vector is passed to a fully-connected layer that comprises 512 neurons. The ReLU function is applied to its output.

A dropout layer is added with a dropout rate of 0.5 to avoid overfitting.

Finally, in some embodiments, the output of the fully-connected layer is passed to a softmax layer, which computes a probability distribution over six activity classes.

A dimensionality reduction may be performed in some embodiments using principal components analysis (PCA) on the normalized features. PCA is a linear dimensionality reduction using the singular-value decomposition of the data to project them to a lower dimensional space. PCA also provides the values of explained variance for each created component. Therefore, it is possible to choose the components that contribute most to the variance of the data, thus reducing the dimensions of the data. The performance of the implementation is measured in terms of the classification quality, the on-device throughput, and the size of the network.

The training parameters of the model are the window size N_{w} of the input, the epochs e of the training, the parameters of the optimizer momentum and learning rate. In some implementations, values of e=100, optimizer set to 0.9, and a learning rate of 0.01 were employed. The training may be performed for two different window sizes, N_{w}, of 50 and 100 to replicate the evaluation of the reference implementation.

With the use of CNN models and their statistical features, the model is trained to recognize activity patterns such as moving and turning. The accelerometer and gyroscope sensor data are transmitted via this layer in order to train and categorize the activity, and this becomes the corpus of patterns during data training.

Referring now to FIG. 3, a process flow diagram is shown of a machine learning process 300 in an illustrative embodiment. The machine learning process 300, in some embodiments, may be operated at least in part using the anomaly detection module 116 of FIG. 1. The process in FIG. 3 includes steps 302-308, although it is to be appreciated that in other embodiments, more, or fewer, steps may be employed. The machine learning process 300, in at least some embodiments, may be performed iteratively, where the time between iterations can be specified (e.g., by a user). In one example embodiment, the time between iterations can be about five minutes, but longer or shorter times may be used.

Step 302 includes obtaining one or more input signals. For example, the one or more input signal may comprise one or more streams of sensor data corresponding to the sensors 112.

Step 304 includes a test to determine whether an anomaly is detected. If an anomaly is detected, then the process continues to step 306, otherwise, the machine learning process 300 returns to step 302.

Step 306 includes identifying and performing one or more recommended actions. For example, step 306 may include identifying the best action out of a set of chosen actions, where the action corresponds to one or more independent variables of a machine learning model (e.g., implemented by anomaly detection module 116). As an example, step 306 can include generating one or more alerts and/or providing instructions for correcting improperly performed actions and/or omitted actions.

Step 308 is optional and includes obtaining feedback for actions recommended at step 306, which can be used to improve the machine learning model. For example, the feedback can be obtained from an end user on the usefulness of the identified recommended actions, such as by rating the ability of the actions to detect, prevent and/or mitigate a detected anomaly.

It is to be appreciated that the feedback provided at step 308 can help provide more effective and efficient results. For example, the feedback can help the machine learning model learn to distinguish between a minor deviation from an expected sequence of actions and more significant deviations. Such a machine learning process can be trained on data from events that have occurred and/or the machine learning process may be run using hypothetical data generated in connection with a model or simulation. As the machine learning process progresses, the model may be continuously improved. Thus, the machine learning process may comprise, or consist of, a closed-loop feedback system for continuous improvement of the model.

It is to be appreciated that this particular process shows just one example implementation of a portion of a machine learning technique, and alternative implementations of the process can be used in other embodiments.

It is noted that the automated actions to mitigate against potential anomalies can include both preemptive actions (e.g., before an anomaly actually impacts an assembled item being fabricated) and recovery actions (e.g., after an anomaly at least partially affects an assembled item being fabricated). It is to be understood that such actions can include actions that directly affect assembled items (or components) resulting from the sequence of steps, as well as actions that may indirectly affect assembled items (or components) related to the sequence of steps, for example.

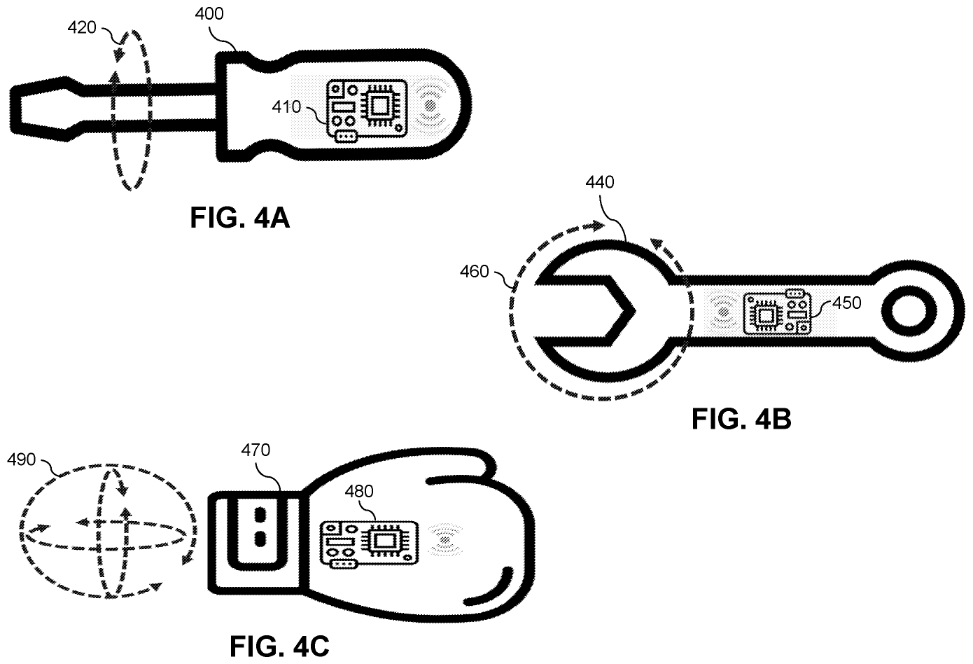

FIGS. 4A through 4C illustrate exemplary edge instruments 400, 440, 470, respectively, in accordance with illustrative embodiments. The edge instruments 400 and 440, 470 comprise processor-based tools, such as a screwdriver and a wrench, respectively, for performing repetitive tasks and the edge instrument 470 comprises a processor-based glove for performing repetitive tasks. In at least some embodiments, the edge instruments 400, 440, 470 each comprise an SoC 410, 450, 480, respectively, having one or more sensors, a sensor data processing module, an anomaly detection module and a mitigation action module configured to perform machine learning-based anomaly detection for repetitive tasks, in a similar manner as the edge instrument 110-1 of FIG. 1.

In addition, as shown in FIGS. 4A through 4C, the edge instruments 400, 440, 470 each further comprise a wireless transmitter, as shown by the respective wireless transmitter symbol. In some embodiments, the wireless transmitter in each edge instrument 400, 440, 470 is used to communicate with a local device (e.g., a local server) that executes a training process using training data provided by one or more of the edge instruments 400, 440, 470. In addition, the wireless transmitter in each edge instrument 400, 440, 470 may be used to communicate alerts or other notifications to one or more users or a local device.

FIGS. 4A through 4C also illustrate one or more rotation axes 420, 460, 490, as shown by the dashed circles, for the respective edge instruments 400, 440, 470.

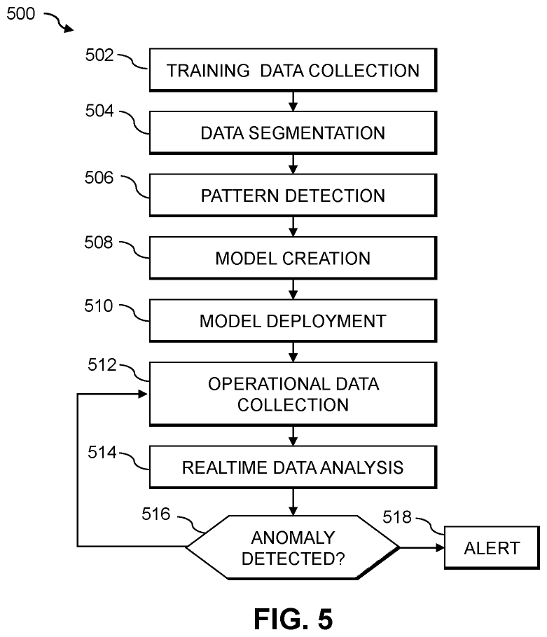

FIG. 5 is a flow diagram illustrating an exemplary implementation of a process 500 for machine learning-based anomaly detection for repetitive tasks performed using edge instruments, in accordance with an illustrative embodiment. A training portion of the process 500 comprises steps 502, 504, 506 and 508. The training portion may be performed in some embodiments by a training server, such as a local server or an on-cloud server. The trained model is then deployed in step 510 to one or more edge instruments and an anomaly detection and mitigation phase is performed by the one or more edge instruments in steps 512, 514, 516 and 518.

The training data is collected in step 502. In the example of FIG. 5, the repetitive tasks may be associated with a particular activity performed in an assembly line, for example. The proper sensors to monitor the particular activity may be identified, and the identified sensors may be attached to an edge instrument to capture the sensor data. Thus, the training data collected in step 502 would be sensor data associated with the particular activity. The raw sensor data is received, for example, by a local training server performing the training, e.g., as a wireless transmission from the one or more edge instruments. Noise may optionally be removed from the sensor data by the local training server before being used for the training process. The training data may comprise sensor data collected from multiple users to avoid errors.

In step 504, the filtered sensor data is segmented into different movements (e.g., a sequence of steps) within the particular activity, such as picking up a tool (e.g., an edge instrument), moving the tool and rotating the tool (e.g., a number of screwdriver turns or partial turns). One or more patterns are then detected in the segmented sensor data in step 506, for example, using one or more regression models to obtain weights, which are then used to create a model in step 508.

As noted above, the trained model is then deployed in step 510 to one or more edge instruments comprising the sensors to monitor the activities of one or more workers or other users. The anomaly detection module applies the trained model using on-device sensor data analyses to detect deviations from the learned activity patterns. In some embodiments, the on-device sensor data analyses perform anomaly detection using very little power, for example, on the order of milliwatts or less.

During a performance of a repetitive task, the sensors collect the operational data in step 512. The sensor data processing module in a given edge instrument (e.g., edge instrument 400) transforms the sensor data from the sensors of the edge instrument into a format that can be consumed by the anomaly detection module of the edge instrument (e.g., by compressing the sensor data and/or reducing noise in the sensor data, as discussed further below).

The anomaly detection module of the edge instrument processes the filtered storage drives and performs a real-time data analysis in step 514 to identify any deviation from the learned patterns. A test is performed in step 516 to determine if an anomaly is detected. If it is determined in step 516 that an anomaly is not detected, then program control returns to step 512 to continue monitoring the real-time sensor data. If, however, it is determined in step 516 that an anomaly is detected, then program control proceeds to step 518 where an alert may be generated (e.g., reporting a deviation from an expected pattern as one or more potential defects) or another automated action may be initiated, for example, by the mitigation action module of the edge instrument.

FIG. 6 is a process diagram illustrating a process 600 for training of a machine learning model to identify patterns in training data and a use of the trained machine learning model for anomaly detection, according to one embodiment of the disclosure. The process comprises a training phase 610 and an anomaly detection phase 620. As noted above, the training phase 610 may be performed in some embodiments by a training server, such as a local server or an on-cloud server.

In the example of FIG. 6, the training phase 610 comprises identifying an activity of a worker, such as a worker screwing one or more screws into a computing device being fabricated), and attaching one or more sensors (for example, as part of an edge instrument, such as edge instrument 400) for monitoring the identified activity. The sensor data from the one or more sensors is then collected as the worker performs the identified activity. The collected sensor data may then be processed to reduce noise, and a self-learning process is performed to identify patterns in the processed data. A machine learning model is then created with the identified patterns. The trained machine learning model may optionally be compressed (e.g., to reduce an amount of data and computing power associated with the trained machine learning model). The trained machine learning model is then deployed to one or more edge instruments.

In the anomaly detection phase 620, the activity (e.g., a repetitive task) of a worker is initially identified and one or more sensors are attached to, or embedded in, an edge instrument, such as the edge instrument 400, used by the worker to perform the repetitive task. The trained machine learning model in the edge instrument is employed to detect deviations from the learned patterns. One or more notifications may be generated when an anomaly (e.g., a deviation from the learned patterns) is detected. In some embodiments, alerts may be transmitted by the edge instrument, using the embedded wireless transmitter, to one or more nearby users and/or systems.

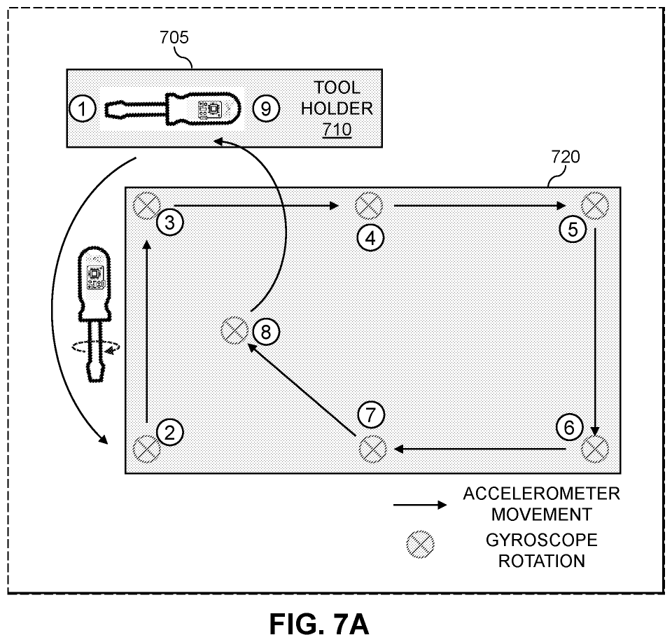

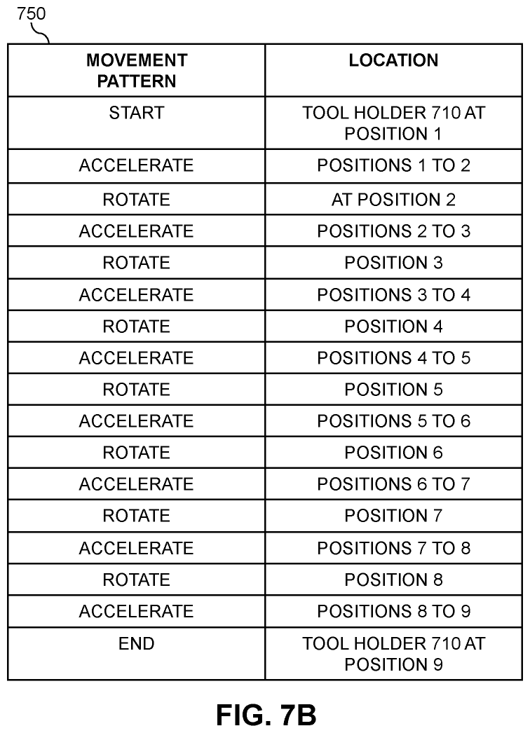

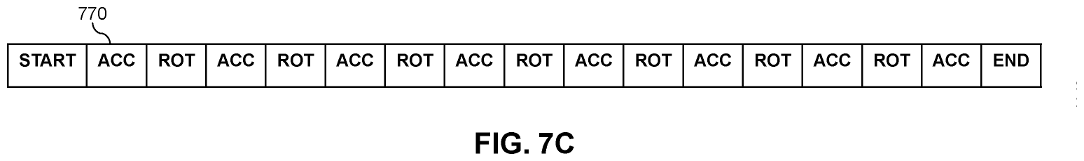

FIG. 7A illustrates an exemplary edge instrument 705 (e.g., a screwdriver) being used for a repetitive task in accordance with an illustrative embodiment. In the example of FIG. 7A, for a normal performance of a repetitive task, such as assembling an item 720, such as a laptop, the following sequence of steps are performed:
an assembler (e.g., an assembly worker) picks up the edge instrument 705 from a tool holder 710 at position 1;
the assembler then picks up a first screw and positions the first screw at position 2 of an item 720 being assembled, such as a laptop, and rotates the screwdriver to insert the first screw;
the assembler then picks up a second screw and positions the second screw at position 3 of the item 720 and rotates the screwdriver to insert the second screw;
the assembler then picks up a third screw and positions the third screw at position 4 of the item 720 and rotates the screwdriver to insert the third screw;
the assembler then picks up a fourth screw and positions the fourth screw at position of the item 720 and rotates the screwdriver to insert the fourth screw;
the assembler then picks up a fifth screw and positions the fifth screw at position 6 of the item 720 and rotates the screwdriver to insert the fifth screw;
the assembler then picks up a sixth screw and positions the sixth screw at position 7 of the item 720 and rotates the screwdriver to insert the sixth screw;
the assembler then picks up a seventh screw and positions the seventh screw at position 8 of the item 720 and rotates the screwdriver to insert the seventh screw; and
the assembler then returns the edge instrument 705 to the tool holder 710 at position 9.

FIG. 7B comprises a table 750 identifying the sequence of steps associated with the repetitive task of FIG. 7A in accordance with an illustrative embodiment. In the example of FIG. 7B, the table 750 identifies each movement associated with the sequence of steps of FIG. 7A and the corresponding position location with respect to the tool holder 710 or designated positions of the item 720 being assembled, such as a laptop. Thus, for each movement, the table 750 identifies the corresponding position where the movement occurs.

FIG. 7C illustrates a short-hand representation 770 of the sequence of steps associated with the repetitive task of FIG. 7A in accordance with an illustrative embodiment. In the example of FIG. 7C, the short-hand representation 770 comprises a sequence of steps or actions, selected from the list comprising start, accelerate (“acc”), rotate (“rot”) and end.

The microcontroller embedded in the edge instrument 705 detects each of these motions associated with FIGS. 7A through 7C, by collecting the orientation from a gyroscope (e.g., gyroscope 214) and acceleration from the accelerometer (e.g., accelerometer 212) embedded in the edge instrument 705. The data includes orientations collected from the gyroscope sensor (e.g., gₓ, g_{y}, g_{z}) and acceleration data collected from the accelerometer (e.g., aₓ, a_{y}, a_{z}).

As noted above, the edge instrument 705, in some embodiments, may also include a sensor data processing module (e.g., sensor data processing module 114) and an anomaly detection module (e.g., anomaly detection module 116). The sensor data processing module transforms the sensor data from the embedded gyroscope and accelerometer into a format that can be consumed by the anomaly detection module (e.g., by compressing the sensor data and/or reducing noise in the sensor data). The anomaly detection module employs at least one trained machine learning model that analyzes the processed sensor data and detects potential anomalies in the sequence of steps associated with the task of FIGS. 7A through 7C.

As discussed herein, a training process learns patterns of activity (e.g., the sequence of steps shown in FIG. 7A) and maps the sequence of steps to a corpus. The at least one trained machine learning model may employ a pattern searching technique, such as an Aho-Corasick algorithm or another string-searching algorithm, to identify multiple strings in a given text. For example, the number of rotations in a given string may be counted and compared to an amount indicated in the corpus. In the above example, seven rotations must be determined as soon as possible.

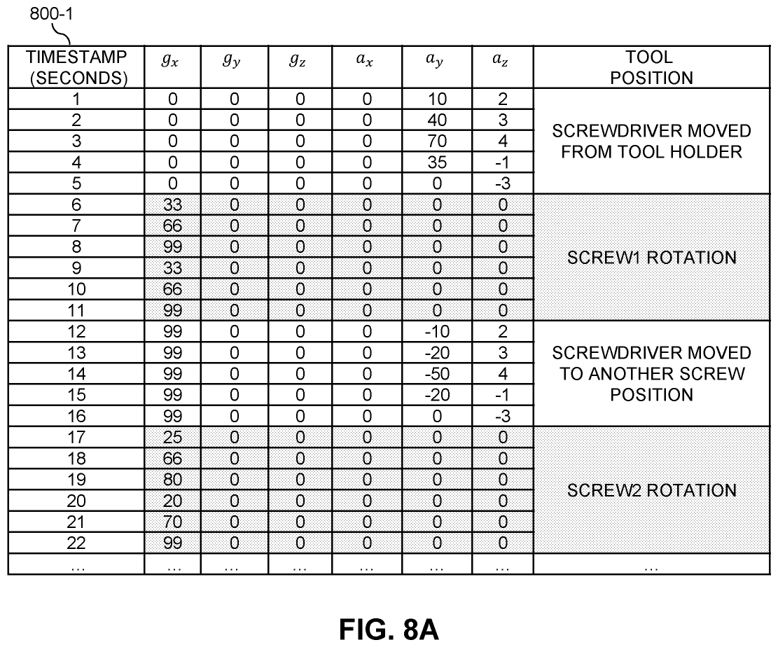

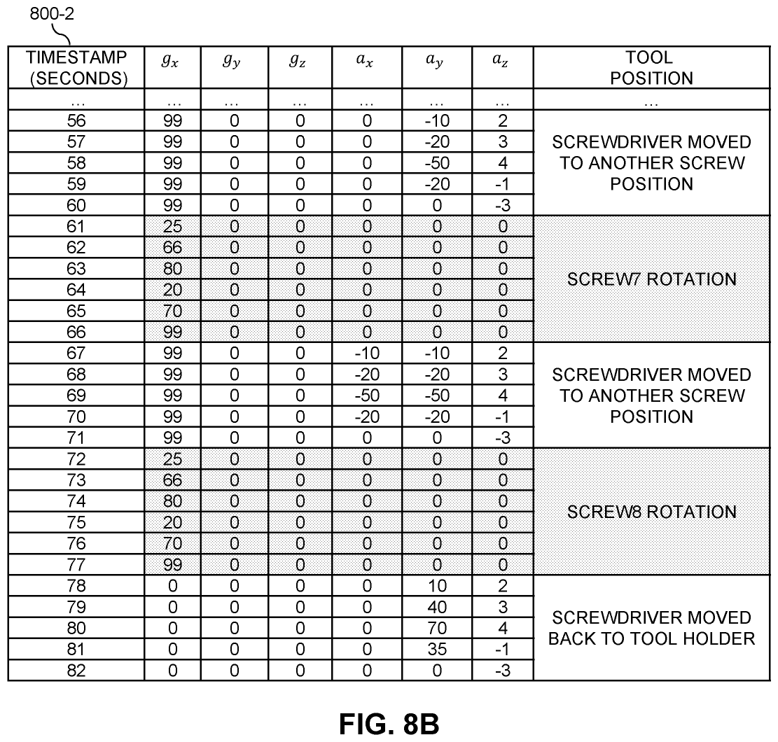

FIGS. 8A and 8B, collectively, comprise a table 800-1, 800-2 recording sensor readings generated by the embedded gyroscope and accelerometer of an exemplary edge instrument, over time, for a sequence of steps associated with a repetitive task, in accordance with an illustrative embodiment. In the example of FIGS. 8A and 8B, the sensor data is shown after the noise has been reduced, for example, using an embedded sensor data processing module 114 of the exemplary edge instrument. It can be observed in FIGS. 8A and 8B that the sensor data for the gyroscope (e.g., gₓ, g_{y}, g_{z}) does not demonstrate any rotation while the edge instrument is in acceleration (e.g., while the edge instrument is being moved from one position to another), and the sensor data for the accelerometer (e.g., a_{y}, a_{y}, a_{z}) does not have any movement when the gyroscope is operating (e.g., rotating). In some embodiments, the noise that results from minor movement while rotating or minor rotation while moving is filtered out. The rows marked with shading illustrate rotation actions and the rows marked without shading illustrate acceleration actions (e.g., movement from one position to another).

If an accelerometer is positioned horizontally with its Z-axis pointing upwards, against the force of gravity, then the Z-axis output of the sensor will be 1 g (9.81 m/s). The X-axis and Y-axis outputs, on the other hand, will be zero, as the gravitational force is perpendicular to these axes and has no effect on them. If the sensor is turned upside down, the Z-axis output will be −1 g. Thus, the results of the accelerometer sensor can range from −1 g to 1 g based on the orientation of the accelerometer with respect to gravity. This information can be used to calculate the position angle of the accelerometer.

The output values of the accelerometer are dependent on the specified sensitivity, which can range from −2 g to +16 g. The default sensitivity is +/−2 g, thus the output is divided by 256 to obtain readings in the range of −1 and +1 g.

Along the X, Y, and Z axes, a gyroscope monitors rotational velocity (or rate of change of angular position over time). The outputs of the gyroscope are in degrees per second, in at least some embodiments. To calculate the angular location, the rotational velocity is integrated (e.g., aggregated). The system can monitor gravitational acceleration along all three axes, and the angle of orientation of the gyroscope can be derived. Precise sensor orientation information is obtained, in some embodiments, by combining the accelerometer and gyroscope data.

If a gyroscope axis is rotated anticlockwise, in at least some embodiments, the value associated with that axis will be positive. The rotation may be counterclockwise from a user perspective if the user is at a positive X, Y, or Z number. In the case of rotation in the clockwise direction, the value associated with that axis will be negative. The first, second, and third values in the values array represent the rotation speeds along the X, Y, and Z axes.

In some embodiments, with the three outputs of the gyroscope sensor (e.g., gₓ, g_{y}, g_{z}) and the three outputs of the accelerometer (e.g., a_{y}, a_{y}, a_{z}), an edge instrument comprising the gyroscope and the accelerometer may be considered a six-axis motion tracking device or a six degrees of freedom (6DoF) device.

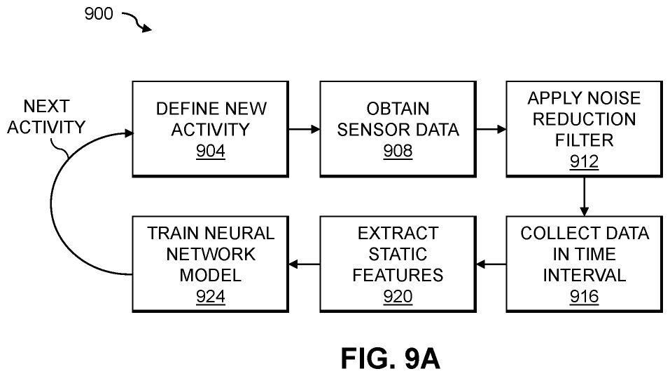

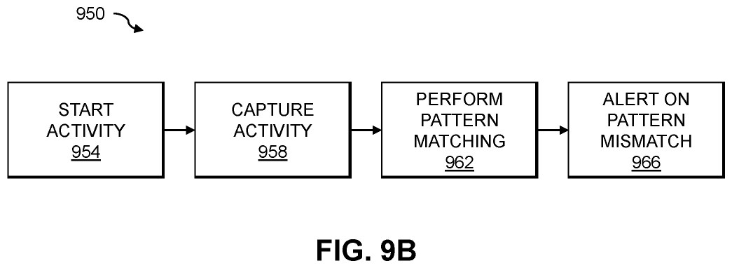

FIG. 9A is a flow diagram illustrating an exemplary implementation of a process 900 that trains a machine learning model to identify patterns in training data, according to an embodiment of the disclosure. In the example of FIG. 9A, a new activity (for example, with a new sequence of steps) of a worker is defined in step 904. An edge instrument with appropriate sensors (such as a gyroscope and an accelerometer) for monitoring the new activity is associated with the new activity and the sensors are used to obtain sensor data in step 908 as a user performs the new activity. A noise reduction filter is applied to the sensor data in step 912, as described in more detail above. The processed sensor data is collected in step 916 in a designated time interval. Static features are extracted from the processed sensor data in step 920, and a neural network model is trained in step 924 to identify patterns in the processed sensor data. The process 900 may be repeated if there are additional activities to be learned.

FIG. 9B is a flow diagram illustrating an exemplary implementation of a process 950 that employs the trained machine learning model of FIG. 9A for anomaly detection, according to an embodiment of the disclosure. In the example of FIG. 9B, an activity of a user is started in step 954 and the activity is captured in step 958 using an edge instrument having embedded sensors (such as a gyroscope and an accelerometer).

The process 950 performs pattern matching in step 962, as described herein, to identify any deviations from an expected sequence of steps (e.g., from learned patterns). One or more alerts (e.g., notifications) are sent or other automated actions are performed in step 966 when a pattern mismatch (e.g., an anomaly) is detected.

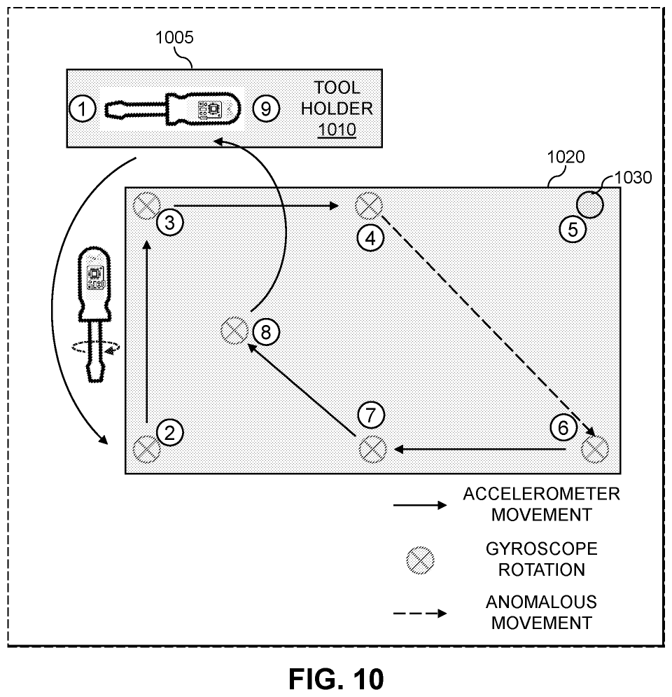

FIG. 10 illustrates an exemplary edge instrument 1005 being used for a repetitive task in the presence of an anomalous sequence of steps, in accordance with an illustrative embodiment. In the example of FIG. 10, the same repetitive task is performed to assemble a laptop, as discussed above in conjunction with FIG. 7A. The performance of the repetitive task proceeds, as follows:
an assembler (e.g., an assembly worker) picks up the edge instrument 1005 from a tool holder 1010 at position 1;
the assembler then picks up a first screw and positions the first screw at position 2 of an item 1020 being assembled, such as a laptop, and rotates the screwdriver to insert the first screw;
the assembler then picks up a second screw and positions the second screw at position 3 of the item 1020 and rotates the screwdriver to insert the second screw; and
the assembler then picks up a third screw and positions the third screw at position 4 of the item 1020 and rotates the screwdriver to insert the third screw.

The next expected action is for the assembler to pick up a fourth screw and position the fourth screw at position 5 of the item 1020 to rotate the screwdriver to insert the fourth screw. The worker, however, fails to perform this step (for example, due to an interruption, work fatigue or another reason), as shown by the dashed lined from position 4 to position 6 associated with an anomalous movement, bypassing position 5, resulting in a missing screw 1030. In other examples, the worker may fail to sufficiently tighten a given screw (e.g., indicated by an anomalous number of rotations of the screwdriver).

The assembler then picks up a fifth screw and positions the fifth screw at position 6 of the item 1020 and rotates the screwdriver to insert the fifth screw; picks up a sixth screw and positions the sixth screw at position 7 of the item 1020 and rotates the screwdriver to insert the sixth screw; picks up a seventh screw and positions the seventh screw at position 8 of the item 1020 and rotates the screwdriver to insert the seventh screw; and the assembler then returns the edge instrument 1005 to the tool holder 1010 at position 9.

The anomalous action of failing to pick up the fourth screw and position the screw at the proper position of the item 1020 to rotate the screwdriver to insert the fourth screw is detected by machine learning model of the edge instrument (as one or more of the required segments of the repetitive tasks might be missing in the data collected from at least one of the sensors) and an appropriate automated action may be performed (such as generating an alert to the assembler about the quality error by highlighting the screw that is not meeting the defined process).

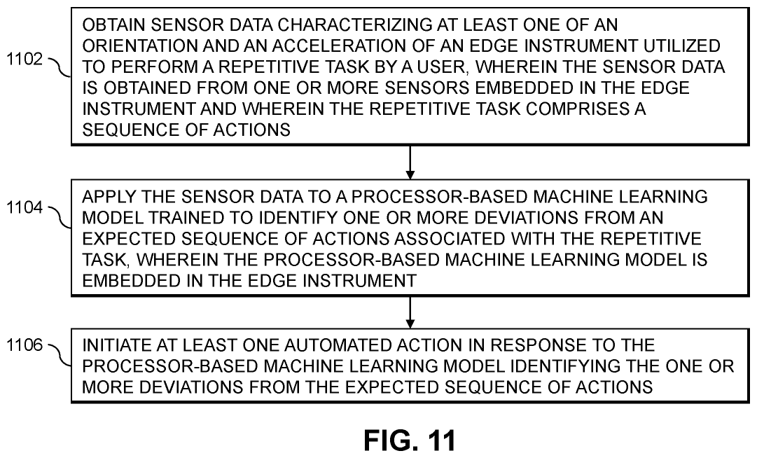

FIG. 11 is a flow diagram illustrating an exemplary implementation of a process for machine learning-based anomaly detection for repetitive tasks performed using edge instruments, in accordance with an illustrative embodiment. In the example of FIG. 11, sensor data characterizing at least one of an orientation and an acceleration of an edge instrument utilized to perform a repetitive task by a user is obtained in step 1102. The sensor data may be obtained from one or more sensors embedded in the edge instrument and the repetitive task may comprise a sequence of actions. The orientation of the edge instrument may be determined using a gyroscope embedded in the edge instrument and the acceleration of the edge instrument may be determined using an accelerometer embedded in the edge instrument.

In step 1104, the sensor data is applied to a processor-based machine learning model trained to identify one or more deviations from an expected sequence of actions associated with the repetitive task. The sensor data may be transformed (e.g., compressing the sensor data and/or reducing noise in the sensor data) into at least one designated format prior to applying the sensor data to the processor-based machine learning model. The processor-based machine learning model may be embedded in the edge instrument. The processor-based machine learning model may be compressed prior to being embedded in the edge instrument. The processor-based machine learning model may be trained to identify the one or more deviations from the expected sequence of actions using training data obtained from one or more sensors embedded in an edge instrument during a performance of the repetitive task by at least one user.

At least one automated action is initiated in step 1106 in response to the processor-based machine learning model identifying the one or more deviations from the expected sequence of actions. The at least one automated action may comprise generating an alert and/or providing one or more remediation steps to address the one or more deviations from the expected sequence of actions.

The particular processing operations and other network functionality described in conjunction with FIGS. 3, 5, 6, 9A, 9B and 11, for example, are presented by way of illustrative example only, and should not be construed as limiting the scope of the disclosure in any way. Alternative embodiments can use other types of processing operations to provide functionality for machine learning-based anomaly detection for repetitive tasks performed using edge instruments. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

It should also be understood that the disclosed techniques for machine learning-based anomaly detection for repetitive tasks performed using edge instruments can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for machine learning-based anomaly detection for repetitive tasks performed using edge instruments may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although it is to be appreciated that numerous other cloud infrastructure arrangements could be used.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based repetitive task anomaly detection engine, or portions thereof, are illustratively implemented for use by tenants of such a multi-tenant environment.

Cloud infrastructure as disclosed herein can include cloud-based systems. Virtual machines provided in such systems can be used to implement at least portions of a repetitive task anomaly detection platform in illustrative embodiments. The cloud-based systems can include object stores.

In some embodiments, the cloud infrastructure additionally or alternatively comprises a plurality of containers implemented using container host devices. The containers may run on virtual machines in a multi-tenant environment, although other arrangements are possible. The containers may be utilized to implement a variety of different types of functionalities within the storage devices. For example, containers can be used to implement respective processing devices providing compute services of a cloud-based system. Again, containers may be used in combination with other virtualization infrastructure such as virtual machines implemented using a hypervisor.

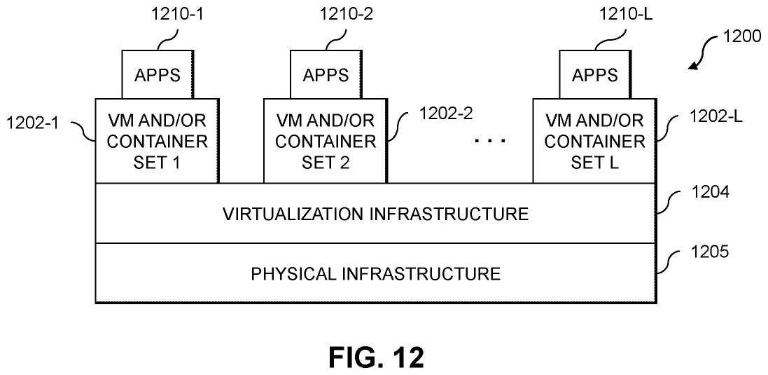

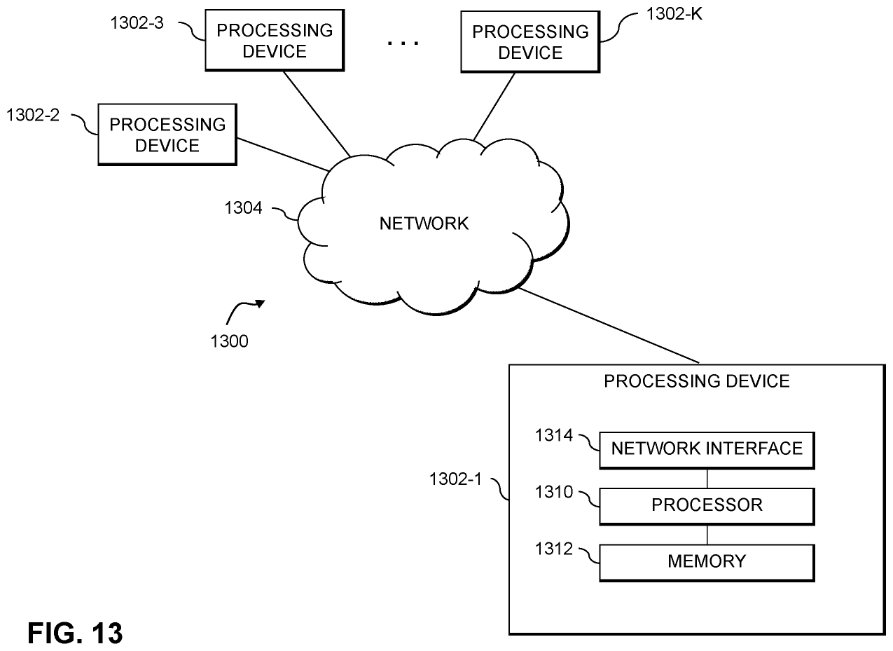

Illustrative embodiments of processing platforms will now be described in greater detail with reference to FIGS. 12 and 13. These platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of the information processing system 100. The cloud infrastructure 1200 comprises multiple VMs and/or container sets 1202-1, 1202-2 . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups.

The cloud infrastructure 1200 further comprises sets of applications 1210-1, 1210-2 . . . 1210-L running on respective ones of the VMs/container sets 1202-1, 1202-2 . . . 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. Such implementations can provide repetitive task anomaly detection functionality of the type described above for one or more processes running on a given one of the VMs. For example, each of the VMs can implement repetitive task anomaly detection control logic and associated functionality for mitigating detected deviations from an expected sequence of steps.

A hypervisor may have an associated virtual infrastructure management system. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for containers running on bare metal hosts, or containers running on VMs. The containers are illustratively implemented using respective kernel control groups of the operating system. Such implementations can provide repetitive task anomaly detection functionality of the type described above for one or more processes running on different ones of the containers. For example, a container host device supporting multiple containers of one or more container sets can implement one or more instances of repetitive task anomaly detection control logic and associated functionality for mitigating detected deviations from an expected sequence of steps.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises at least a portion of the given system and includes a plurality of processing devices, denoted 1302-1, 1302-2, 1302-3 . . . 1302-K, which communicate with one another over a network 1304. The network 1304 may comprise any type of network, such as a WAN, a LAN, a satellite network, a telephone or cable network, a cellular network, a wireless network such as WiFi or WiMAX, or various portions or combinations of these and other types of networks.

The processing device 1302-1 in the processing platform 1300 comprises a processor 1310 coupled to a memory 1312. The processor 1310 may comprise a microprocessor, a microcontroller, an ASIC, an FPGA or other type of processing circuitry, as well as portions or combinations of such circuitry elements, and the memory 1312, which may be viewed as an example of a “processor-readable storage media” storing executable program code of one or more software programs.

Articles of manufacture comprising such processor-readable storage media are considered illustrative embodiments. A given such article of manufacture may comprise. for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 12 or 13, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide containers.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining sensor data characterizing at least one of an orientation and an acceleration of an edge instrument utilized to perform a repetitive task by a user, wherein the sensor data is obtained from one or more sensors embedded in the edge instrument and wherein the repetitive task comprises a sequence of actions;
applying the sensor data to a processor-based machine learning model trained to identify one or more deviations from an expected sequence of actions associated with the repetitive task, wherein the processor-based machine learning model is embedded in the edge instrument; and
initiating at least one automated action in response to the processor-based machine learning model identifying the one or more deviations from the expected sequence of actions;
wherein the method is performed by at least one processing device comprising a processor coupled to a memory.

2. The method of claim 1, wherein the processor-based machine learning model is compressed prior to being embedded in the edge instrument.

3. The method of claim 1, wherein the orientation of the edge instrument is determined using a gyroscope embedded in the edge instrument.

4. The method of claim 1, wherein the acceleration of the edge instrument is determined using an accelerometer embedded in the edge instrument.

5. The method of claim 1, further comprising transforming the sensor data into at least one designated format prior to applying the sensor data to the processor-based machine learning model.

6. The method of claim 5, wherein the transforming the sensor data comprises one or more of compressing the sensor data and reducing noise in the sensor data.

7. The method of claim 1, wherein the at least one automated action comprises one or more of generating an alert and providing one or more remediation steps to address the one or more deviations from the expected sequence of actions.

8. The method of claim 1, wherein the processor-based machine learning model is trained to identify the one or more deviations from the expected sequence of actions using training data obtained from one or more sensors embedded in an edge instrument during a performance of the repetitive task by at least one user.

9. A non-transitory processor-readable storage medium having stored therein program code of one or more software programs, wherein the program code when executed by at least one processing device causes the at least one processing device to perform the following steps:
obtaining sensor data characterizing at least one of an orientation and an acceleration of an edge instrument utilized to perform a repetitive task by a user, wherein the sensor data is obtained from one or more sensors embedded in the edge instrument and wherein the repetitive task comprises a sequence of actions;
applying the sensor data to a processor-based machine learning model trained to identify one or more deviations from an expected sequence of actions associated with the repetitive task, wherein the processor-based machine learning model is embedded in the edge instrument; and
initiating at least one automated action in response to the processor-based machine learning model identifying the one or more deviations from the expected sequence of actions.

10. The non-transitory processor-readable storage medium of claim 9, wherein the processor-based machine learning model is compressed prior to being embedded in the edge instrument.

11. The non-transitory processor-readable storage medium of claim 9, wherein the orientation of the edge instrument is determined using a gyroscope embedded in the edge instrument.

12. The non-transitory processor-readable storage medium of claim 9, wherein the acceleration of the edge instrument is determined using an accelerometer embedded in the edge instrument.

13. The non-transitory processor-readable storage medium of claim 9, further comprising one or more of compressing the sensor data and reducing noise in the sensor data.

14. The non-transitory processor-readable storage medium of claim 9, wherein the at least one automated action comprises one or more of generating an alert and providing one or more remediation steps to address the one or more deviations from the expected sequence of actions.

15. An apparatus comprising:
at least one processing device comprising a processor coupled to a memory;
the at least one processing device being configured to implement the following steps:
obtaining sensor data characterizing at least one of an orientation and an acceleration of an edge instrument utilized to perform a repetitive task by a user, wherein the sensor data is obtained from one or more sensors embedded in the edge instrument and wherein the repetitive task comprises a sequence of actions;
applying the sensor data to a processor-based machine learning model trained to identify one or more deviations from an expected sequence of actions associated with the repetitive task, wherein the processor-based machine learning model is embedded in the edge instrument; and
initiating at least one automated action in response to the processor-based machine learning model identifying the one or more deviations from the expected sequence of actions.

16. The apparatus of claim 15, wherein the processor-based machine learning model is compressed prior to being embedded in the edge instrument.

17. The apparatus of claim 15, wherein the orientation of the edge instrument is determined using a gyroscope embedded in the edge instrument.

18. The apparatus of claim 15, wherein the acceleration of the edge instrument is determined using an accelerometer embedded in the edge instrument.

19. The apparatus of claim 15, further comprising one or more of compressing the sensor data and reducing noise in the sensor data.

20. The apparatus of claim 15, wherein the at least one automated action comprises one or more of generating an alert and providing one or more remediation steps to address the one or more deviations from the expected sequence of actions.
